(19) United States
(12) Patent Application Publication
(10) Pub. No.: US 2025/0043152 A1
(43) Pub. Date: Feb. 6, 2025

(54) Acrylate Film Composition to Prevent the Migration of Small Molecules

(71) Applicant: 3M INNOVATIVE PROPERTIES COMPANY, St. Paul, MN (US)

(72) Inventor: Kyung Hwan Yoon, Gyeonggi (KR)

(21) Appl. No.: 18/718,564

(22) PCT Filed: Nov. 30, 2022
(86) PCT No.: PCT/IB2022/061593

§ 371 Date: Jun. 11, 2024

Related U.S. Application Data
(60) Provisional application No. 63/265,440, filed on Dec. 15, 2021.

(51) Int. Cl. C09J 7/24; C09J 7/30

(52) U.S. Cl. CPC C09J 7/24; C09J 7/30; C09J 2203/318; C09J 2301/1242; C09J 2301/416; C09J 2433/006

(57) ABSTRACT

The present invention is a laminate including a post-UV curable adhesive layer, a UV absorbing adhesive layer, and a substrate film positioned between the post-UV curable adhesive layer and the UV absorbing adhesive layer. The substrate film is acrylate-based and includes a cross-linker. The substrate film has a glass transition temperature (Tg) of between about 25° C. and about 90° C.

### FIELD OF THE INVENTION

The present invention is related generally to the field of optically clear adhesives. In particular, the present invention is an optically clear laminate that prevents migration of small molecules.

### BACKGROUND

Optically clear adhesives (OCAs) are commonly used to attach components in display assemblies. For example, an OCA layer is used to attach the cover glass to the polarizer/OLED display assembly. This OCA layer is known as a top OCA layer. The top OCA layer is typically in the form of a post-ultraviolet (UV) curable pressure sensitive adhesive in order to fill the ink step of a printed black matrix, or bezel. To make the laminate using the top OCA layer, an uncured OCA is typically laminated between the cover glass and the polarizer and then cured by UV radiation to increase its cohesion and thus, reliability.

As the desirability to have thinner displays has increased, thinner polarizers are being used to reduce the total thickness of the display. However, as the function of a polarizer is to allow light waves of a specific polarization to pass through the polarizer while blocking light waves of other polarizations, the reduction in thickness of the polarizer can decrease the ability of the polarizer to block ultraviolet radiation from a light source (UV cut function). To alleviate this issue and to protect the OLED panel from harmful UV light, another layer of the display assembly must function to block ultraviolet radiation. While a UV cut function can be added relatively easily to an OCA layer positioned between the polarizer and the OLED panel, it is more complicated to add a UV cut function to a top OCA layer positioned between the cover glass and the polarizer as the top OCA layer is often post UV-cured to achieve reliability after filling in the ink step, as mentioned above. The UV cut function in this layer is highly likely to prevent this post UV-curing.

One solution to this issue in a single layer structure is for an OCA layer to contain both a UV absorber and residual double bonds with a long wavelength photoinitiator that can be solvent-coated (as disclosed, for example, in US2020/0325372 A1 to Henkel) or hotmelt-coated (as disclosed, for example, in DE102012222813A1 to TESA and WO2017/138544A1 to Mitsubishi). However, although a UV coating method is economical and sustainable, it can be complicated to prepare such an OCA layer by UV coating. This is because the post-cure of this OCA is achieved by the hydrogen capture mechanism of benzophenone, of which the absorption spectrum often completely overlaps with the absorption spectrum of the UV absorber. While progress has been made using a minimized amount of UV absorber, its UV cut off performance is unknown.

Another solution has been to use a multi-layer structure. In a first embodiment of a multi-layer structure, a UV blocking film is positioned between a post-UV curable OCA and a pressure sensitive adhesive (PSA). In a second embodiment of a multi-layer structure, a substrate film is positioned between a post-UV curable OCA and a UV blocking PSA. The second embodiment has been found to be more favorable because the UV absorber can bleed out from the substrate film to the post-UV curable OCA if both layers are in contact with each other.

### SUMMARY

In one embodiment, the present invention is a laminate including a post-UV curable adhesive layer, a UV absorbing adhesive layer, and a substrate film positioned between the post-UV curable adhesive layer and the UV absorbing adhesive layer. The substrate film is acrylate-based and includes a cross-linker. The substrate film has a glass transition temperature (T_{g}) of between about 25° C. and about 90° C.

In another embodiment, the present invention is an optically clear laminate including a post-UV curable adhesive layer, a substrate film positioned adjacent the post-UV curable adhesive, and a UV absorbing adhesive layer positioned adjacent the substrate. The substrate film includes an acrylate and a cross-linker and has a glass transition temperature (T_{g}) of between about 25° C. and about 90° C.

### DETAILED DESCRIPTION

The present invention is a laminate which can prevent the migration of small molecules, such as ultraviolet absorbers (UVA) through the laminate. The laminate generally includes a post-ultraviolet (UV) curable adhesive layer, a UV absorbing adhesive layer, and a substrate film positioned between the post-UV curable adhesive layer and the UV absorbing adhesive layer. The substrate film is acrylate-based and has a particular glass transition temperature. Because the laminate includes the post-UV curable adhesive layer, the laminate can be applied to a substrate such as a cover glass with a printed ink bezel and then cured to achieve high reliability, or blister resistance. This results in minimal to no bubble generation at high temperatures. The laminate can be used in various applications, such as in a display assembly. For example, with this invention, the top optically clear adhesive (OCA) layer can provide a UV cut function to an OLED, thus lengthening its lifetime and at the same time providing an ink-step coverage as high as conventional post-UV-curable OCAs. As UV absorbers from the UV absorbing adhesive layer cannot migrate to the post-UV curable adhesive layer, the UV cure performance of the post-UV curable adhesive layer is not degraded even with extended storage times.

The laminate of the present invention generally includes a post-UV curable adhesive layer, a UV absorbing adhesive layer, and a substrate film positioned between the post-UV curable adhesive layer and the UV absorbing adhesive layer. The post-UV curable adhesive layer is often composed of acrylate polymers containing either reactive carbon double bonds with unreacted photoinitiators (for example, as disclosed in US2020/0325372 A1, DE102012222813A1, WO2017/138544A1) or benzophenone acrylate connected to polymer chains (for example, as disclosed in WO2011112447 A2, WO2011112508 A1, WO201325443 A2, WO201362996 A1, and WO201669097 A2). In the first case, by post-UV curing, the double bonds can react with each other to make crosslinks. In the second case, by post-UV curing, benzophenones can connect to another polymer chain via hydrogen abstraction mechanism. The post-UV curable pressure sensitive adhesive layer allows the laminate to fill the ink step of a printed black matrix, or bezel, before post curing and acquire enough reliability by post curing. In one embodiment, a commercially suitable post-UV curable adhesive layer includes, but is not limited to, 3M CEF30™ acrylate OCA, available from 3M Company, Saint Paul, MN. In one embodiment, the post-UV curable adhesive layer is a pressure sensitive adhesive.

The UV absorbing adhesive layer of the present invention is a pressure sensitive adhesive containing UV absorbers. In one embodiment, the UV absorbing adhesive layer includes between about 0.05% and about 30% UVAs, particularly between about 0.5% and about 15% UVAs, and more particularly between about 0.5% and about 5% UVAs. The UV absorbing adhesive layer is transparent and has a refractive index close to both the substrate film and the post UV curable adhesive layer. An example of a suitable The UV absorbing adhesive layer includes, but is not limited to: an acrylate, silicone, rubber, or the like. In one embodiment, the UV absorbing adhesive layer has a thickness of between about 5 μm and about 250 μm, particularly between about 10 μm and about 100 μm, and more particularly between about 20 μm and about 50 μm. An example of a suitable UV absorbing adhesive layer includes, but is not limited to, a pressure sensitive acrylate adhesive including about 13 pph of UV absorber added to a 3M CEF31™ pressure sensitive acrylate adhesive, available from 3M Company in Saint Paul, MN.

The substrate film of the present invention is positioned between the post-UV curable adhesive layer and the UV absorbing adhesive layer and functions to prevent small molecules, including UVAs, from penetrating through the substrate film. This prevents UVAs from migrating into the post-UV curable adhesive layer and inhibiting the post-cure. The substrate film is also flexible, tough, and does not evolve outgas. The substrate film is sufficiently flexible and tough such that is does not break during the lamination process due to stress from ink-step filling. Outgassing is not desired as it can cause delamination between the substrate film and the adhesive layers. The substrate film of the present invention is also a good adherend with or without surface treatments, such as corona or plasma treatment. In one embodiment, the substrate film has no color, dents, scratches, defects, nor birefringence so that it can be used in a display assembly

The substrate film is acrylate-based and includes a cross-linker. The substrate film according to one embodiment of the present invention contains a copolymer of a monomer mixture containing about 25 to about 90 parts by mass of an alkyl (meth)acrylate, about 5 to about 50 parts by mass of hydrophilic monomers, for example, hydroxyl group containing monomers. The copolymer contains substantially no acidic groups. An alkyl (meth)acrylate is a main component that constitutes the copolymer contained in the substrate film. It is possible to use a straight chain, branched chain or cyclic monofunctional (meth)acrylate having 1 to 14 carbon atoms in the alkyl group as the alkyl (meth)acrylate. Examples of useful alkyl (meth)acrylates include, but are not limited to: methyl (meth)acrylate, ethyl (meth)acrylate, n-propyl (meth)acrylate, isopropyl (meth)acrylate, n-butyl (meth)acrylate, isobutyl (meth)acrylate, pentyl (meth)acrylate, isoamyl (meth)acrylate, 2-methylbutyl (meth)acrylate, n-hexyl (meth)acrylate, n-octyl (meth)acrylate, 2-ethylhexyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, cyclohexyl (meth)acrylate, isobornyl (meth)acrylate, and the like, and combinations thereof. In cases where a copolymer is formed by polymerizing a monomer mixture by irradiating with radiation such as ultraviolet radiation or an electron beam, it is advantageous for the alkyl (meth)acrylate to be a highly reactive alkyl acrylate.

It is possible to increase the cohesive force of the substrate film by using a cyclic (meth)acrylate having a relatively rigid structure, such as cyclohexyl (meth)acrylate or isobornyl (meth)acrylate. In certain embodiments, the alkyl (meth)acrylate contains at least one compound selected from among the group consisting of cyclohexyl methacrylate and isobornyl methacrylate. In some embodiments, these cyclic (meth)acrylates constitute about 25 mass % or more, particularly about 35 mass % or more, more particularly about 45 mass % or more, and even more particularly about 80 mass % or less of the whole embodiment.

A hydrophilic monomer may be included among the monomer components. By using a hydrophilic monomer, it is possible to improve the cohesive strength of the substrate film and impart the substrate film with hydrophilic properties. If a substrate film imparted with hydrophilic properties is used, for example, on an image display device, clouding due to water vapor condensation can be controlled because of the ability of the substrate film to absorb water vapor within the image display device. This is especially advantageous when the surface protecting layer is of a material having low vapor permeability and/or when the image display device to which the optically clear adhesive laminate is applied is used in a high-temperature, high-humidity environment. Examples of such hydrophilic monomers include ethylenically-unsaturated monomers having acidic groups such as carboxylic acid, sulfonic acid, and the like, vinyl amide, N-vinyl lactam, (meth)acrylamide, and mixtures thereof. A non-exhaustive list of specific examples includes acrylic acid, methacrylic acid, itaconic acid, maleic acid, styrenesulfonic acid, N-vinylpyrrolidone, N-vinylcaprolactam, N,N-dimethyl(meth)acrylamide, N,N-diethyl(meth)acrylamide, (meth)acrylonitrile, and mixtures thereof. From considerations of adjusting the elastic modulus of the (meth)acrylic copolymer to ensure wetting properties with respect to the adherend, a (meth)acrylate hydroxyalkyl ester with 4 or less carbon atoms in the alkyl group; a (meth)acrylate containing an oxyethylene group, an oxypropylene group, an oxybutylene group, or a group having a plurality of these linked together; a (meth)acrylate having a carbonyl group in an alcohol residue, a mixture of these, or the like can be used as the hydrophilic monomer.

The hydroxyl group-containing monomer contributes to an improvement in the moisture vapor transmission rate of the substrate film, prevention of moisture condensation, and so on. Hydrogen bonding via hydroxyl groups can, in some cases, enhance the cohesive force of the substrate film. It is possible to use a monomer having an ethylenically unsaturated group and the number of hydroxyl groups in the hydroxyl group-containing monomer can be 1 or 2 or more. Examples of useful hydroxyl group-containing monomers include, but are not limited to: hydroxyl group-containing (meth)acrylates such as 2-hydroxyethyl (meth)acrylate, 2-hydroxypropyl (meth)acrylate, 3-hydroxypropyl (meth)acrylate and 4-hydroxybutyl (meth)acrylate, hydroxyl group-containing (meth)acrylamides such as 2-hydroxyethyl (meth)acrylamide and N-hydroxypropyl (meth)acrylamide, and combinations thereof. It is also possible to use a hydroxy-functional monomer derived from a glycol derived from ethylene oxide or propylene oxide. One example of this type of monomer is poly(propylene glycol) (meth)acrylate having hydroxyl groups as terminal groups, which can be obtained as Bisomer PPA 6 from Cognis, Germany. In cases where a copolymer is formed by polymerizing a monomer mixture by irradiating with radiation such as ultraviolet radiation or an electron beam, it is advantageous for the hydroxyl group-containing monomer to be a highly reactive hydroxyl group-containing acrylate.

A hydrophilic monomer having a basic group, such as an amino group, can also be used. A (meth)acrylic copolymer obtained from a monomer containing a hydrophilic monomer having a basic group can be blended with a (meth)acrylic copolymer obtained from a monomer containing a hydrophilic monomer having an acid group, allowing coating thickness to be increased by increasing the viscosity of the coating solution, adhesive strength to be controlled, and so forth. A non-exhaustive list of specific examples includes, but is not limited to: N, N-dimethyl aminoethyl acrylate, N,N-dimethyl aminoethyl methacrylate, N,N-diethylaminoethyl methacrylate, N,N-dimethylaminoethyl acrylamide, N,N-dimethylaminoethyl methacrylamide, N,N-dimethylaminopropyl acrylamide, N,N-dimethylaminopropyl methacrylamide, vinylpyridine, vinylimidazole, and the like. The above hydrophilic monomers may be used singly or in combination. From considerations of more effectively preventing the clouding described above and obtaining high flexibility and strength, the amount of hydrophilic monomer, if a hydrophilic monomer is used, it is generally about 5 mass % or more and about 40 mass % or less and particularly about 10 mass % or more and about 30 mass % or less, based on the total monomer component mass.

The cross-linker introduces a crosslinked structure into the copolymer during the polymerization process. Examples of suitable cross-linker include, but are not limited to: difunctional (meth)acrylates such as 1,4-butane diol di(meth)acrylate, 1,6-hexane diol di(meth)acrylate, 1,9-nonane diol di(meth)acrylate, 1,10-decane diol di(meth)acrylate, neopentyl glycol di(meth)acrylate, ethylene glycol di(meth)acrylate, di(ethylene glycol) di(meth)acrylate, tri(ethylene glycol) di(meth)acrylate, an ethoxylated bisphenol A di(meth)acrylate, tricyclodecane dimethanol di(meth)acrylate, poly(ethylene glycol) di(meth)acrylate, poly(propylene glycol) di(meth)acrylate, and 2-hydroxy-3-acryloyloxypropyl (meth)acrylate; and polyfunctional (meth)acrylates such as trimethyloylpropane tri(meth)acrylate, pentaerythritol tri(meth)acrylate, pentaerythritol tetra(meth)acrylate, di(trimethylolpropane) tetra(meth)acrylate, dipentaerythritol penta(meth)acrylate, and dipentaerythritol hexa(meth)acrylate. In one embodiment, a suitable cross-linker of the present invention includes, but is not limited to, 1,6-Hexanediol diacrylate (HDDA). Of these crosslinkable monomers, difunctional (meth)acrylates can be advantageously used due to ease of control. In cases where a copolymer is formed by polymerizing a monomer mixture by irradiating with radiation such as ultraviolet radiation or an electron beam, it is advantageous for the cross-linkable monomer to be a highly reactive difunctional acrylate or polyfunctional acrylate.

The amount of cross-linker will vary on the application and the target property. In one embodiment, the cross-linker functions to prevent the substrate film from becoming brittle. The addition of cross-linker increases the glass transition temperature as well as the Young's modulus to the substrate film. Therefore, the cross-linker provides higher cohesive strength to the substrate film. In one embodiment, the substrate film includes between about 0.01 and about 50 parts per hundred cross-linker, particularly about 0.01 and about 20 parts per hundred cross-linker, and more particularly about 0.1 and about 10 parts per hundred cross-linker.

In practice, the post-UV curable adhesive layer is laminated on a first side the substrate film and the UV absorbing adhesive layer is laminated on a second side of the substrate film. This forms an OCA laminate or simply laminate. Tangent delta is defined as the ratio of loss modulus (G″) to storage modulus (G′), which shows the contribution of liquid nature to the viscoelastic property of a polymeric material. Generally, a more crosslinked polymer has a lower tangent delta than a less crosslinked polymer. The substrate film is considered to block the migration of UVA from the UV absorbing adhesive layer to the post-UV curable adhesive layer if the tangent delta of the laminate measured at 100° C. is the same or substantially the same immediately after the laminate has been UV cured (denoted as tangent delta A) and after the laminate has been in storage for 5 days at 50° C. and then UV cured (denoted as tangent delta B). On the other hand, if the substrate film does not block the migration of UVA, the tangent delta B will be higher than the tangent delta A. This will be because the migrated UVA will have inhibited the action of the post-curing agent. In one embodiment, the cured laminate has a tangent delta difference of less than about 0.05, and particularly less than about 0.02 between tangent delta A and tangent delta B.

The glass transition temperature of the substrate film is related to the tangent delta difference of the laminate. The glass transition temperature (T_{g}) of the substrate film is significant as it impacts the migration of UVA through the substrate film. As the glass transition temperature of the substrate film increases, the difference between tangent delta A and tangent delta B decreases. Therefore, if the glass transition temperature of the substrate film is too low, UVA will migrate through the substrate film. If the glass transition temperature is too high and the substrate film becomes too hard, the substrate film will prevent the OCA laminate from filling the ink-step. In one embodiment, the substrate film has a glass transition temperature of between about 25° C. and about 90°, particularly a T_{g} of between about 30° C. and about 80° C., and more particularly a T_{g} of between about 30° C. and about 65° C.

In one embodiment, the laminate has a thickness of between about 100 μm and about 200 μm, and particularly about 150 μm. Generally, the post-UV curable adhesive layer should be as thick as possible while the substrate film and the UV absorbing adhesive layer are as thin as possible. In one embodiment, the post-UV curable adhesive layer has a thickness of about 100 μm and each of the UV absorbing adhesive layer and the substrate film has a thickness of about 25 μm.

The laminate may optionally fill an ink step produced by the bezel-ink printed on the cover glass positioned adjacent to the post-UV curable adhesive layer. One function of the post-UV curable adhesive layer is to fill the ink step of the bezel ink printed on the cover glass. When the laminate is used to fill in an ink step, the coverable ink step has a thickness of about 40% of a thickness of the post-UV curable adhesive layer, particularly a thickness of about 27% of a thickness of the post-UV curable adhesive layer, and more particularly a thickness of about 20% of a thickness of the post-UV curable adhesive layer.

In one embodiment, the refractive index of the substrate film is substantially similar to the refractive index of the post-UV curable adhesive layer. When the substrate film has a refractive index substantially different from the post-UV curable adhesive layer, the total reflection increases and percent transmittance decreases as a result. Thus, the substrate film has a refractive index substantially similar to the adhesive layers in order to achieve enhanced brightness and contrast. This is achieved preferably by the substrate film having a similar composition to the adhesive layers. For example, if the substrate film is located between acrylate OCAs with a refractive index of 1.48, the substrate film having a refractive index close to 1.48 provides the least light loss by interface reflection. In one embodiment, the post-UV curable adhesive, the UV absorbing adhesive layer, and the substrate film each has a refractive index of between about 1 and about 2, particularly between about 1.25 and about 1.75, and more particularly between about 1.45 and about 1.55.

In one embodiment, the substrate film has a Young's modulus of between about 200 MPa and about 1.3 GPa and particularly a Young's modulus of between about 350 MPa and about 1 GPa.

In one embodiment, the laminate of the present invention, and thus each layer of the laminate, is optically clear. As used herein, the term “optically clear” refers to a material that has a haze of less than about 5%, particularly less than about 2% and more particularly less than about 1%; a luminous transmission of greater than about 88%, particularly greater than about 89%, and more particularly greater than about 90%; and an optical clarity of greater than about 98%, particularly greater than about 99%, and more particularly greater than about 99.5% when cured. Typically, the clarity, haze, and transmission are measured on a construction in which the layer is held between two transparent glass sheets. The measurement is then taken on the entire construction, including the layer and the substrates. Both the haze and the luminous transmission can be determined using, for example, ASTM-D 1003-92. The optical measurements of transmission, haze, and optical clarity can be made using, for example, a BYK Gardner haze-gard plus 4725 instrument (Geretsried, Germany). The BYK instrument uses an illuminant “C” source and measures all the light over that spectral range to calculate a transmission value. Haze is the percentage of transmitted light that deviates from the incident beam by more than 2.5°. Optical clarity is evaluated at angles of less than 2.5°. Typically, the laminate is substantially visually free of bubbles.

The laminate of the present invention can be used in a display assembly. The display assembly can further include another substrate, another adhesive layer, or a combination thereof. As used herein, the term “adjacent” can be used to refer to two layers that are in direct contact or that are separated by one or more thin layers, such as primer or hard coating. Often, adjacent layers are in direct contact. Additionally, the laminate can be positioned between two substrates, wherein at least one of the substrates is an optical film. Optical films intentionally enhance, manipulate, control, maintain, transmit, reflect, refract, absorb, retard, or otherwise alter light that impinges upon a surface of the film. Films included in the laminates include classes of material that have optical functions, such as polarizers, interference polarizers, reflective polarizers, diffusers, colored optical films, mirrors, louvered optical film, light control films, transparent sheets, brightness enhancement film, anti-glare, and anti-reflective films, and the like. Films for the provided laminates can also include retarder plates such as quarter-wave and half-wave phase retardation optical elements. Other optically clear films include anti-splinter films and electromagnetic interference filters.

In some embodiments, the resulting laminates can be optical elements or can be used to prepare optical elements. As used herein, the term “optical element” refers to an article that has an optical effect or optical application. The optical elements can be used, for example, in electronic displays, architectural applications, transportation applications, projection applications, photonics applications, and graphics applications. Suitable optical elements include, but are not limited to, glazing (e.g., windows and windshields), screens or displays, cathode ray tubes, and reflectors.

Exemplary optically clear substrates include, but are not limited to: a display panel, such as liquid crystal display, an OLED display, a touch panel, electrowetting display or a cathode ray tube, a window or glazing, an optical component such as a reflector, polarizer, diffraction grating, mirror, or cover lens, another film such as a decorative film or another optical film.

Representative examples of optically clear substrates include glass and polymeric substrates including those that contain polycarbonates, polyesters (e.g., polyethylene terephthalates and polyethylene naphthalates), polyurethanes, poly(meth)acrylates (e.g., polymethyl methacrylates), polyvinyl alcohols, polyolefins such as polyethylenes, polypropylenes, and cellulose triacetates. Typically, cover lenses can be made of glass, polymethyl methacrylates, or polycarbonate.

To form the laminate of the present invention, each layer is first prepared independently. The UV absorbing adhesive layer is first laminated to a first side of the substrate film. The post-UV curable adhesive layer is then laminated to a second side of the substrate film. One of skill in the art would understand that the lamination order can also be reversed without departing from the intended scope of the present invention. The laminate is then heated in an autoclave for complete lamination. In one embodiment, the laminated is autoclaved at about 50° C. under about 5.5 kgf/cm² of air for about 10 minutes.

In practice, the laminate of the present invention can be used as the top OCA layer of a display assembly. In one embodiment, the laminate is first laminated to a polarizer film, which is already assembled on an OLED panel by a roll-laminator. The other side of the laminate is then laminated to a cover glass window with a printed ink-bezel by a vacuum-press laminator. The entire module then is autoclaved for further lamination. In another embodiment, the laminate is first laminated to the cover glass window by a roll-laminator and the polarizer-OLED panel is laminated to the other side of the laminate by a vacuum-press laminator. The entire whole module is then autoclaved for further lamination.

### Examples

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis.

A listing of materials used is listed in Table 1 below.

TABLE 1
Materials

| Name | Chemical | Function | Source |
|---|---|---|---|
| 2EHA | 2-ethylhexyl acrylate | Monomer | LG Chem, |
| | | | Korea |
| 2EHMA | 2-ethylhexyl methacrylate | Monomer | Evonik, |
| | | | Germany |
| 2HEA | 2-hydroxyethyl acrylate | Monomer | BASF, |
| | | | Germany |
| IBOA | isobornyl acrylate | Monomer | Sartomer, |
| | | | France |
| ACM | acrylamide | Monomer | Samchun, |
| | | | Korea |
| IBOMA | isobornyl methacrylate | Monomer | Evonik, |
| | | | Germany |
| HDDA | hexanediol diacrylate | Crosslinker | Allnex, |
| | | | Belgium |
| Omnirad | 2,2-dimethoxy-1,2- | Photoinitiator | IGM Resins, |
| BDK | diphenyl ethan-1-one | | Netherlands |
| Tinuvin | 2-(2H-Benzotriazol- | UV absorber | BASF, |
| 928 | 2-yl)-6-(1-methyl-1- | | Germany |
| | phenylethyl)-4-(1,1,3,3- | | |
| | tetramethylbutyl) phenol | | |

### Example Preparation

Each example material and comparative example material for the substrate film was prepared similarly. The preparation of Comparative example, CEX01, is described to illustrate. CEX01 was prepared by mixing 250 g 2EHA, 50 g 2EHMA, 75 g 2HEA, and 125 g IBOA with 0.75 g Omnirad BDK photoinitiator. The solution was purged with nitrogen for 5 minutes and exposed to 365 nm UV light until the temperature increased by 5° C. An additional 1.5 g Omnirad BDK and crosslinker were added to the syrup. The syrup was injected between two silicone-release coated PET liner films at a thickness of 25 μm and cured by UV blacklight fluorescent lamp at energy of 2 J/cm². All other examples were prepared in same manner but with compositions varying as shown in Table 2.

TABLE 2
Example and Comparative Example compositions

| | % | | | | | | pph |
|---|---|---|---|---|---|---|---|
| Example | 2EHA | 2EHMA | 2HEA | IBOA | ACM | IBOMA | HDDA |
| CEX01 | 50 | 10 | 15 | 25 | — | — | — |
| CEX02 | 40 | 10 | 15 | 35 | — | — | — |
| CEX03 | 30 | 10 | 15 | 45 | — | — | — |
| CEX04 | 20 | 10 | 15 | 55 | — | — | — |
| CEX05 | 10 | 10 | 15 | 65 | — | — | — |
| CEX06 | — | 10 | 15 | 75 | — | — | — |
| CEX07 | — | 10 | 15 | 72 | 3 | — | — |
| CEX08 | — | — | 15 | 75 | — | 10 | — |
| CEX09 | 50 | 10 | 15 | 25 | — | — | 20 |
| CEX10 | 40 | 10 | 15 | 35 | — | — | 20 |
| CEX11 | 30 | 10 | 15 | 45 | — | — | 20 |
| EX01 | 20 | 10 | 15 | 55 | — | — | 20 |
| EX02 | 10 | 10 | 15 | 65 | — | — | 20 |
| EX03 | — | 10 | 15 | 75 | — | — | 20 |
| EX04 | — | 10 | 15 | 72 | 3 | — | 20 |
| EX05 | — | — | 15 | 75 | — | 10 | 20 |
| CEX12 | 50 | 10 | 15 | 25 | — | — | 40 |
| CEX13 | 40 | 10 | 15 | 35 | — | — | 40 |
| CEX14 | 30 | 10 | 15 | 45 | — | — | 40 |

### Measured Material Properties

The glass transition temperature (T_{g}) and Young's modulus were measured for the varying compositions listed in Table 2. T_{g} was measured on a DSC 2500 instrument from TA Instruments. About 10 mg of a polymer sample was placed in a closed aluminum hermetic pan. The temperature was raised from about −50° C. to about 100° C. at 10° C./min. The T_{g} was determined as a mid-temperature at the glass transition shift. The Young's modulus was measured on a Discovery HR3 rheometer from TA Instruments with a tension fixture installed. An example or comparative example sample with a thickness of 25 μm was folded 8 times to reach a thickness of 200 μm. The folded specimen was cut to 10 mm width and 50 mm length. The specimen was then fixed at the tension fixture with a 20 mm gap and pulled at a 100 μm/sec rate at 25° C. The stress and strain were recorded and the slope between the stress at 0% strain and the stress at 1% strain was calculated as the Young's modulus. The results are shown in Table 3 below.

TABLE 3
T_{g} and Young's Modulus Measurements

| | | T_{g} (° C.) of the | Young's modulus of the |
|---|---|---|---|
| | HDDA | substrate film | substrate film (MPa) |
| CEX01 | — | −25.5 | 0.20 |
| CEX02 | — | −13.2 | 0.45 |
| CEX03 | — | 0.7 | 1.4 |
| CEX04 | — | 14.8 | 36.5 |
| CEX05 | — | 29.7 | Brittle |
| CEX06 | — | 42.8 | Brittle |
| CEX07 | — | 46.7 | Brittle |
| CEX08 | — | 51.3 | Brittle |
| CEX09 | 20 | −5.4 | 10.6 |
| CEX10 | 20 | 4.4 | 11.8 |
| CEX11 | 20 | 17.5 | 35.1 |
| EX01 | 20 | 29.9 | 352.7 |
| EX02 | 20 | 42.3 | 959.1 |
| EX03 | 20 | 46.9 | 1,338 |
| EX04 | 20 | 46.0 | 1,555 |
| EX05 | 20 | 49.0 | 1,831 |
| CEX12 | 40 | 11.0 | 22.0 |
| CEX13 | 40 | 16.6 | 36.9 |
| CEX14 | 40 | 21.0 | 175.4 |

The effect of adding HDDA can be observed by comparing CEX09 and CEX01. The only difference between CEX01 and CEX09 is that CEX09 included 20 pph HDDA. CEX09 showed an increase in T_{g} and Young's modulus when compared to CEX01 (from −25.5° C. to −5.4° C. and 0.2 MPa to 10.6 MPa, respectively). By further comparison, the addition of 40 pph of HDDA to CEX01, newly formed CEX12 had a T_{g} and Young's modulus values increase to 11.0° C. and 22.0 MPa, respectively. While CEX05 to CEX 08 had a T_{g} above 25° C., they were fundamentally brittle due to a lack of crosslinkers, which aids in providing tough physical properties to the polymer in a glassy state. However, when 20 pph HDDA was added to CEX05 through CEX08, creating EX01 through EX04, the samples had a Young's modulus higher than 350 MPa. From these comparisons, it can be seen that the addition of a crosslinker provided higher cohesional strength to the substrate film.

As shown in the Table 3, the addition of HDDA has the effect of increasing both glass transition temperature as well as Young's modulus.

### Substrate Material Comparison

As mentioned previously, substrate films having a refractive index close to n=1.48, which is a typical refractive index of an acrylate PSA, provides the least light loss inside the laminate by interface reflection due to optical matching with the adhesives. In addition to optical matching, there are other considerations for candidate substrate materials listed in Table 4.

TABLE 4
Substrate Film Candidates

| | | % T | | | |
|---|---|---|---|---|---|
| | | loss by | | | |
| | Refractive | interface | | Young's | |
| | index | reflection | T_{g} | modulus | Other optical |
| | (nD) | (%) | (° C.) | (GPa) | issues |
| Cellulose triacetate | 1.47-1.48 | 0 | 200 | 1.6 | Degradation by |
| (TAC) | | | | | hydrolysis |
| PMMA | 1.49 | 0 | 105 | 2.4-3.4 | |
| Polyolefin | 1.53 | 0.06 | 160-220 | 1.5-2.0 | Retardation |
| Polyimide | 1.58 | 0.21 | >300 | 3.1 | Yellowish |
| Polystyrene | 1.59 | 0.26 | 100-107 | 3.0-3.5 | Brittle |
| Polycarbonate | 1.60 | 0.30 | 147 | 2.6 | Outgas bubble |
| PET | 1.64 | 0.53 | crystalline | 2.0-2.7 | Haze, |
| | | | | | Retardation |
| Polyetheretherketone | 1.67 | 0.73 | 143 | 3.6 | |

The common optical films listed in Table 4 have varied refractive indices. Transmittance loss in percent between two materials in contact was calculated according to a simplified Fresnel equation:

$$\% transmittance loss = \frac{{( {nD}_{1} - {nD}_{2} )}^{2}}{{( {nD}_{1} + {nD}_{2} )}^{2}} \times 100$$

Assuming the nD of two adhesive layers contacting the substrate film is 1.48, each film gave % T loss as listed in Table 4. Those with refractive index difference higher than 0.05 (refractive index higher than 1.53) resulted in significant % T loss. Some of films also had other optical issues, for example: retardation, haze, yellowness, and outgas bubbles. Although TAC and PMMA provided excellent index matching, their high modulus (over 1.5 GPa) prevented ink-step filling of the top OCA (see Table 6).

### OCA Laminate Sample Preparation

The easy liner of a 150 μm thick post UV curable OCA (3M CEF30™) was peeled off and the easy liner of an example or comparative example sample was also peeled off. The easy side of the CEF30™ was roller-laminated on the easy side of a sample. The tight liner of the sample was peeled off and the easy liner of a UV absorbing adhesive layer was peeled off. In these examples, a specially prepared 3M CEF31™ pressure sensitive acrylate adhesive was used as the UV absorbing adhesive layer to form the laminates. 13 pph of BASF Tinuvin 928 m UV absorber was added to a commercial material CEF31™ of 25 μm thickness. This specially prepared CEF31 is called CEF31A in this specification. The easy side of the UV absorbing adhesive layer was roller-laminated on the tight side of a sample. The whole body was pressurized at 50° C., 5.5 kgf/cm² for 10 min for further lamination. This formed the OCA laminate sample, or simply a laminate sample.

### Measured Changes to 50° C. Exposure

Tangent delta is defined as the ratio of loss modulus (G″) to storage modulus (G′), which shows the contribution of liquid nature to the viscoelastic property of a polymeric material. Tangent delta was measured on a Discovery HR3 Rheometer from TA instruments using 8 mm diameter plate geometry. One liner of the OCA laminate sample was peeled off and another OCA laminate sample was prepared in the same manner. The two OCA laminate samples were then laminated together by a roller. Repeating in this manner, OCA laminate samples were stacked until the thickness reached 2 mm. Using a round knife, this laminated sample was cut into a specimen with an 8 mm diameter. The specimen was placed on an 8 mm diameter plate geometry and the other geometry pressed the specimen with a force of 25 g. Tangent delta was measured at 1% strain and 1 Hz frequency at 100° C.

The substrate film is considered to block the migration of UVA from the UV absorbing adhesive layer to the post-UV curable adhesive layer if the tangent delta of the OCA laminate sample measured at 100° C. is the same or substantially the same immediately after the laminate has been UV Cured (tangent delta A) and after the laminate has been stored for 5 days at 50° C. and then UV cured (tangent delta B). At an elevated temperature, for example 50° C., small molecules like UV absorbers acquire high mobility, which accelerates their migration from the UV absorbing adhesive layer to the post UV curable adhesive layer through the substrate film.

TABLE 5
Laminates incorporating Examples and Comparative Examples

| | | | Tan d at 100° C. of the | |
|---|---|---|---|---|
| CEF30 ™: post UV | | | laminate after post-cure | |
| curable OCA. 150 μm | | Tan d at | Cured | Cured |
| Substrate film: examples | | 100° C. | immediately | after 5 |
| and comparative examples. | T_{g} (° C.) | of the | after | days at |
| 25 μm CEF31A: UV | of the | laminate | preparation | 50° C. |
| absorbing version of | substrate | before | (tangent | (tangent |
| CEF31 ™. 25 μm | film | post-cure | delta A) | delta B) |
| CEF30 ™ alone | — | 0.91 | 0.27 | 0.26 |
| CEF30 ™ + CEX01 + CEF31A | −25.5 | 0.91 | 0.71 | 0.90 |
| CEF30 ™ + CEX02 + CEF31A | −13.2 | 0.90 | 0.53 | 0.76 |
| CEF30 ™ + CEX03 + CEF31A | 0.7 | 0.91 | 0.38 | 0.70 |
| CEF30 ™ + CEX04 + CEF31A | 14.8 | 0.90 | 0.30 | 0.43 |
| CEF30 ™ + CEX05 + CEF31A | 29.7 | 0.90 | 0.30 | 0.32 |
| CEF30 ™ + CEX06 + CEF31A | 42.8 | 0.90 | 0.30 | 0.31 |
| CEF30 ™ + CEX07 + CEF31A | 46.7 | 0.90 | 0.29 | 0.30 |
| CEF30 ™ + CEX08 + CEF31A | 51.3 | 0.90 | 0.29 | 0.30 |
| CEF30 ™ + CEX09 + CEF31A | −5.4 | 0.88 | 0.28 | 0.67 |
| CEF30 ™ + CEX10 + CEF31A | 4.4 | 0.89 | 0.28 | 0.64 |
| CEF30 ™ + CEX11 + CEF31A | 17.5 | 0.88 | 0.28 | 0.51 |
| CEF30 ™ + EX01 + CEF31A | 29.9 | 0.88 | 0.27 | 0.29 |
| CEF30 ™ + EX02 + CEF31A | 42.3 | 0.88 | 0.27 | 0.28 |
| CEF30 ™ + EX03 + CEF31A | 46.9 | 0.88 | 0.27 | 0.28 |
| CEF30 ™ + EX04 + CEF31A | 46.0 | 0.88 | 0.27 | 0.28 |
| CEF30 ™ + EX05 + CEF31A | 49.0 | 0.89 | 0.26 | 0.26 |
| CEF30 ™ + CEX12 + CEF31A | 11.0 | 0.87 | 0.27 | 0.54 |
| CEF30 ™ + CEX13 + CEF31A | 16.6 | 0.87 | 0.27 | 0.46 |
| CEF30 ™ + CEX14 + CEF31A | 21.0 | 0.86 | 0.27 | 0.35 |

As shown in the Table 5, the glass transition temperature of the substrate film is related to the tangent delta difference of the laminate. The glass transition temperature (T_{g}) of the substrate film is significant as it impacts the migration of UVA through the substrate film. As the glass transition temperature of the substrate film increased, the tangent delta difference of the laminate between tangent delta A and tangent delta B decreased. CEX 01 to 04 and 09 to 14 have a difference in the tangent delta of greater than 0.02. Although CEX05 to 08 have a difference of less than 0.02, these Comparative Examples samples are fundamentally brittle (see Table 3). All Examples samples have a difference of less than 0.02 and well as good film properties, as shown in Table 3.

### Ink Step Coverage Quality

If the glass transition temperature of the substrate film is too high, the substrate film becomes too hard and will prevent the post UV curable OCA and hence the OCA laminate from filling the ink-step. OCA laminate samples were prepared in the same manner above with CEF30™ and CEF31A. To test the ability of the OCA laminate to cover an ink step, the liner of the UV absorbing adhesive layer in the OCA laminate sample was peeled off and the UV absorbing adhesive layer was laminated to a PET film with 75 μm thickness by a roller. The liner of the post-UV curable adhesive layer in the OCA laminate sample was peeled off and the post-UV curable adhesive layer was laminated to a cover glass window with printed bezel of 40 or 50 μm thickness by a vacuum laminator. The whole laminated body was pressurized at 50° C., 5.5 kgf/cm² for 10 min for further lamination. If one or more bubble appeared at the bezel-OCA overlap, the lamination was considered as failing ink-step filling. For further comparisons, three common optical films were used: 33 μm PMMA (HBS006H) from Mitsubishi Chemical Advanced Materials, Japan; 25 μm PET (SP63B) from SK Hitech and Marketing, Korea; and 25 μm TAC from Hyosung, Korea. The results are shown in Table 6 below.

TABLE 6
Ink Step Quality

| CEF30 ™: post UV curable OCA. 150 μm | | |
|---|---|---|
| Substrate film: examples and comparative examples. 25 μm | 40 μm ink | 50 μm ink |
| CEF31A: UV absorbing version of CEF31 ™. 25 μm | step (27%) | step (33%) |
| CEF30 ™ alone | OK | Delamination line |
| CEF30 ™ + no substrate film + CEF31A | OK | OK |
| CEF30 ™ + 33 μm PMMA + CEF31A | Bubbles | Bubbles |
| CEF30 ™ + 25 μm PET + CEF31A | Bubbles | Delamination line |
| CEF30 ™ + 25 μm TAC + CEF31A | Delamination line | Delamination line |
| CEF30 ™ + CEX05 + CEF31A | Film fracture | Film fracture |
| CEF30 ™ + [CEX05 with HDDA 1 pph] + CEF31A | OK | OK |
| CEF30 ™ + [CEX05 with HDDA 2 pph] + CEF31A | OK | OK |
| CEF30 ™ + [CEX05 with HDDA 5 pph] + CEF31A | OK | Bubbles |
| CEF30 ™ + [CEX05 with HDDA 10 pph] + CEF31A | OK | Bubbles |
| CEF30 ™ + [CEX05 with HDDA 20 pph = EX02] + CEF31A | OK | Bubbles |
| CEF30 ™ + CEX06 + CEF31A | Film fracture | Film fracture |
| CEF30 ™ + [CEX06 with HDDA 1 pph] + CEF31A | OK | OK |
| CEF30 ™ + [CEX06 with HDDA 2 pph] + CEF31A | OK | OK |
| CEF30 ™ + [CEX06 with HDDA 5 pph] + CEF31A | OK | Bubbles |
| CEF30 ™ + [CEX06 with HDDA 10 pph] + CEF31A | OK | Bubbles |
| CEF30 ™ + [CEX06 with HDDA 20 pph = EX03] + CEF31A | OK | Bubbles |

As can be seen in Table 6, commercial films with a T_{g} higher than 90° C. and a modulus higher than 1.5 GPa (for example, PET: crystalline, 2.0-2.7 GPa; PMMA: 105° C., 2.4-3.4 GPa; TAC: 200° C., 1.6 GPa. (See Table 4)) prevented the post-UV curable OCA from filling the ink-step. CEX05 and 06 were broken due to their inherent brittleness during the lamination step. With the addition of HDDA, CEF05 and 06 acquired good film properties. Although the increased amount of HDDA downgraded the ink-step coverage of the OCA laminate sample, EX02 and 03 still provided relatively good ink-step coverage to the OCA laminate sample.

Although the present invention has been described with reference to preferred embodiments, workers skilled in the art will recognize that changes may be made in form and detail without departing from the spirit and scope of the invention.

What is claimed is:

1. A laminate comprising:
a post-UV curable adhesive layer;
a UV absorbing adhesive layer; and
a substrate film positioned between the post-UV curable adhesive layer and the UV absorbing adhesive layer, wherein the substrate is acrylate-based, wherein the substrate film comprises a cross-linker, and wherein the substrate film has a glass transition temperature (T_{g}) of between about 25° C. and about 90° C.

2. The laminate of claim 1, wherein the post-UV curable adhesive layer is optically clear.

3. The laminate of claim 1, wherein the laminate is optically clear.

4. The laminate of claim 1, wherein the substrate film has a T_{g} of between about 30° C. and about 80° C.

5. The laminate of claim 1, wherein the substrate film has a T_{g} of between about 30° C. and about 65° C.

6. The laminate of claim 1, wherein a tangent delta difference of the laminate measured at 100° C. (a) immediately after being UV cured and (b) after being stored for 5 days at about 50° C. and then UV cured, is less than about 0.1.

7. The laminate of claim 1, wherein a tangent delta difference of the laminate measured at 100° C. (a) immediately after being UV cured and (b) after being stored for 5 days at about 50° C. and then UV cured, is less than about 0.05.

8. The laminate of claim 1, further comprising an ink step positioned adjacent the post-UV curable adhesive layer.

9. The laminate of claim 8, wherein the ink step has a thickness of about 40% of a thickness of the post-UV curable adhesive layer.

10. The laminate of claim 1, wherein the substrate film includes between about 1 and about 20 parts per hundred cross-linker.

11. The laminate of claim 1, wherein the laminate has substantially no bubbling.

12. The laminate of claim 1, wherein the substrate film has a Youngs modulus of between about 200 MPa to about 1.3 GPa.

13. An optically clear laminate comprising:
a post-UV curable adhesive layer;
a substrate film positioned adjacent the post-UV curable adhesive, wherein the substrate film comprises:
an acrylate; and
a cross-linker,
wherein the substrate film has a glass transition temperature (T_{g}) of between about 25° C. and about 90° C.; and
a UV absorbing adhesive layer positioned adjacent the substrate film.

14. The optically clear laminate of claim 14, wherein the substrate film has a T_{g} of between about 30° C. and about 80° C.

15. The optically clear laminate of claim 14, wherein a tangent delta difference of the laminate measured at 100° C. (a) immediately after being UV cured and (b) after being stored for 5 days at about 50° C. and then UV cured, is less than about 0.1.

16. The optically clear laminate of claim 14, wherein the substrate includes between about 1 and about 20 parts per hundred cross-linker.

17. The optically clear laminate of claim 14, wherein the laminate has substantially no bubbling.

18. The optically clear laminate of claim 14, wherein the substrate film has a Youngs modulus of between about 200 MPa and about 1.3 GPa.

19. The optically clear laminate of claim 14, wherein a refractive index of the substrate film is substantially similar to a refractive index of the post-curable UV adhesive layer.
